(19) United States
(12) Patent Application Publication
(10) Pub. No.: US 2006/0026897 A1
(43) Pub. Date: Feb. 9, 2006

(54) Plant containers

(76) Inventor: Michael Glover, South Luffenham (GB)

Correspondence Address: KILPATRICK STOCKTON LLP, 1001 WEST FOURTH STREET, WINSTON-SALEM, NC, 27101, US

(21) Appl. No.: 11/011,903

(22) Filed: Dec. 14, 2004

(30) Foreign Application Priority Data
Dec. 15, 2003 (GB) 00329048.3

(51) Int. Cl. A01G 9/02

(52) U.S. Cl. 47/65.8

(57) ABSTRACT

A plant-growing container made of translucent plastics sheet material with a base and sides, and the sides extended at the top by a mulch mat that can be drawn about the stem of the plant at final planting. The container is marked circumferentially with a cutting line indicating an extent of the lower part of the container, which can be removed and discarded.

### FIELD OF THE INVENTION

The invention relates to plant-growing containers, particularly for trees.

### BACKGROUND

Field grown trees are very unreliable when transplanted and can be compared to fish out of water from the time they are lifted out of the ground to the time they are planted again. Low transplantation success has been a key driver for growers to produce their trees in containers with a fully intact and unwounded root system. One grower for example now produces in excess of 100,000 trees per year on 140 acres of land based near Cambridge.

Black containers are traditionally used for containerizing nursery stock but this produces a spiralled root system. In time, these roots thicken forming a constricted mass that finds it difficult to spread out into surrounding soil after planting. Trees planted from black containers tend not to thrive, as they establish poorly anchored root systems and are prone to blow over in strong winds.

### SUMMARY OF THE INVENTION

Aware of these problems we, as the grower mentioned above, turned some years ago to white containers. Originally suggested in Australia to avoid roots reaching an excessive temperature in sunlight, these containers have been found to produce an ideal root system. Far from spiralling round the inside of the container wall, the roots, which show a negative phototropism, remain in the body of the compost and grow downwards, keeping away from the light that passes through the container walls. The result is an untangled root system that looks as though it has been combed vertically downwards, with the roots establishing quickly when planted out as they are not impeding each others growth. White also reflects heat, keeping the roots at the right temperature on hot summer days.

The containers were initially made of polythene and although it produced the desired root system, it was difficult to handle. Aggregate bags with handles—as used by builder's merchants for deliveries of bulk materials—were therefore trialled and these worked well. Having settled on the material and general design we have had similar purpose-made bags produced from double laminated woven polyethylene with ultra violet stabilizer at 4% and the sides comprise a plurality of holes scattered in a non-uniform manner to aid oxygen flow within the compost.

In principle the containers can be of any material that at least for the sides is translucent, so that roots, which avoid light, do not reach the container wall and start growing along it, but the present invention relates to those made up from plastic sheeting, particularly woven or fibre-reinforced plastic sheeting, such as polyethylene, and provides several improvements usable separately or together as set out in the claims, as well as a new method of using existing containers.

Aggregate bags as used by builder's merchants are made in a gusseted construction simply sewn across the bottom so that separate sheets of material do not have to be joined and potentially weakening seams, for the dense materials carried, are avoided. Plant containers have hitherto followed the same construction but we have found it to show disadvantages in use in that roots grow between the different layers resulting in damage and difficulty in removal at planting time. We propose instead a container with discontinuous base and sides seamed together to give flush internal surfaces allowing ready separation from the root ball. Seams of sufficient strength for this application are readily made, and the un-gusseted construction also allows for easy filling during the original planting of the containers with young stock.

A second improvement lies in incorporating a mulch mat in the top of the container. Current containers are provided with a drawstring at the opening, but while these allow the sides to be partly drawn together when the container with its grown plant is dispatched, they do not close the opening. We provide an extension of the edges of the opening with a sheet of material, conveniently permeable and conveniently but not necessarily the same sort of material that the rest of the container is made of, with a drawstring that allows the stem of the plant to be closely surrounded by the material when the string is tightened. At planting, the container wall can then be slit round circumferentially to leave part of the wall in place and the extension sheet as a mulch mat keeping weeds at bay and conserving applied water. At least the drawstring and optionally the whole sheet, in this application, is suitably made of biodegradable material so that the stem of the growing plant once established is not strangled.

A third improvement is in relation to root barriers. Many trees planted in paving or other hard areas are prone to lift them over time as the root system colonises the soil and expands. At present, separate root barriers are used to control this lifting but they are costly to buy and install.

We have seen that the container itself can be used as a root barrier if the upper part of the container wall, around the opening, is left in place at planting. This can be put into effect simply as a new method of planting, with unmodified containers, where the upper part of the walls is normally of folded, double-thickness construction for strength and for attachment of handles. However the new approach is best combined with the use of the mulch mat discussed above. A cutting line may be marked on the wall of a container as a guide to how much to leave.

### BRIEF DESCRIPTION OF THE DRAWINGS

FIG. 1 depicts an embodiment of the present invention.

FIG. 2 depicts the embodiment depicted in FIG. 1 with a portion cut-away to show details of the interior.

FIG. 3 depicts a possible use of the embodiment of FIGS. 1 and 2.

### DETAILED DESCRIPTION OF THE INVENTION

In an embodiment, the present invention provides a plant-growing container comprising a translucent plastics sheet with a base and sides, the sides extended at the top by a mulch mat, having central opening area through which the plant extends, that can be drawn about the stem of the plant at final planting to allow the upper part of the container to remain in place and the lower part to be discarded.

In an embodiment, the plant growing container may further comprise a drawstring running through the mulch mat at the opening to allow the sides to be partly drawn together.

In an embodiment the sides of the container may be marked marked circumferentially with a cutting line indicating an extent of the lower part of the container that may be discarded at planting.

In an embodiment the mulch mat and/or the drawstring is/are biodegradable.

In an embodiment the base and sides of the container are seamed together to give a flush internal surface.

In an embodiment, the translucent plastic material comprises a double laminated woven polyethylene with ultra violet stabilizer.

In an embodiment, the plastic material may be woven or fibre-reinforced.

In an embodiment, the plant-growing container may further comprise a plurality of holes to aid oxygen flow. The holes may be scattered in a non-uniform manner

In an embodiment, the upper part of the container comprises a folded, double-thickness construction.

In another aspect, the present invention provides a method of cultivating trees, comprising using a container of the present invention. In hard-surfaced areas the trees, grown in containers of translucent plastics sheet with a base and sides, are planted with retention of the upper part of the container sides as a root barrier, the lower part of the sides and the base being discarded.

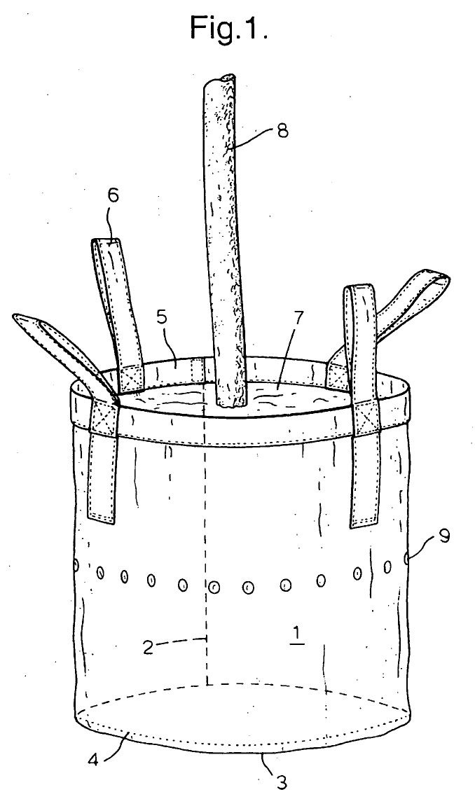

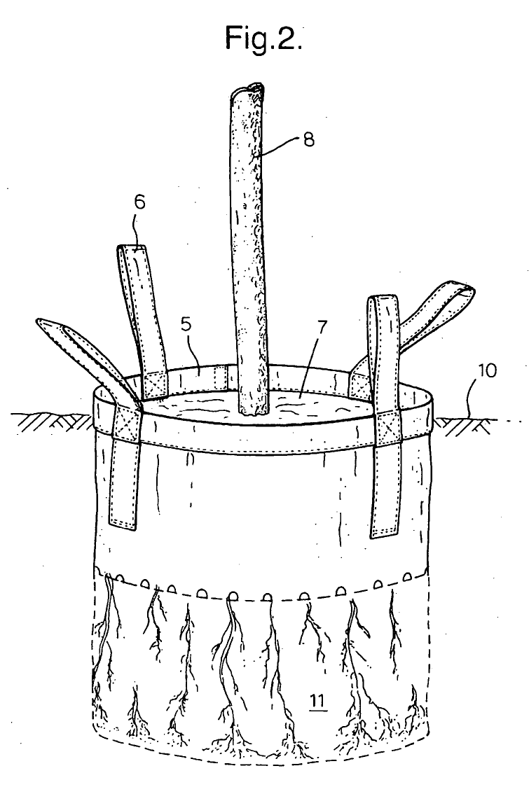

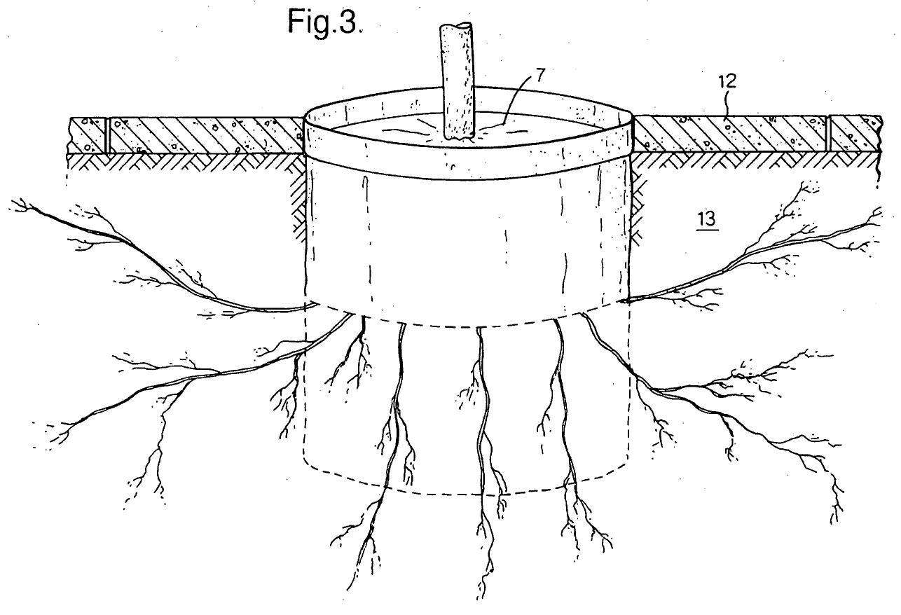

The invention is illustrated in the accompanying drawings, which show in FIG. 1 a container, with a young tree stem, and in FIGS. 2 and 3 the same container with the lower half of the bag removed, as at planting and with the root system after three years. FIG. 3 additionally shows the root barrier concept.

In the drawings, referring to FIG. 1, the container 1 has continuous sides seamed up vertically at 2 and made of light-stabilised double-laminated woven polyethylene. The base 3 is made of the same material, though it need not specifically be, sewn at 4. The top edge 5 is doubled and seamed and handles 6 are provided. A permeable and/or biodegradable skirt/mulch mat 7 surrounds the stem 8 of a tree, pulled up by a drawstring (not shown). At 9 is cutting line.

FIG. 2 shows the container after planting with the soil level at 10 and the root distribution of the tree shown at 11 where the bottom part of the container has been removed and a certain amount of the compost next to the container wall has been lost.

FIG. 3 shows planting in paving slabs 12 with the root system as it will be at some 3 years after planting, well spread and with a root-barrier zone 13 brought into existence by retention of the upper part of the container.

Various embodiments of the invention have been described in fulfillment of the various objects of the invention. It should be recognized that these embodiments are merely illustrative of the principles of the present invention. Numerous modifications and adaptations thereof will be readily apparent to those skilled in the art without departing from the spirit and scope of the present invention. Other embodiments are possible and can be more practical for different applications.

What is claimed is:

1. A plant-growing container comprising:
a translucent plastics sheet with a base and sides, the sides extended at the top by a mulch mat, having central opening area through which the plant extends, that can be drawn about the stem of the plant at final planting.

2. A plant-growing container according to claim 1 further comprising: a drawstring running through the mulch mat at the opening to allow the sides to be partly drawn together.

3. A plant-growing container according to claim 2 wherein the sides are marked circumferentially with a cutting line indicating an extent of the lower part of the container that may be discarded at planting.

4. A plant-growing container according to claim 3, wherein the mulch mat and/or the drawstring is/are biodegradable.

5. A plant-growing container according to claim 4 where the base and sides of the container are seamed together to give a flush internal surface.

6. A plant-growing container according to claim 5 wherein the translucent plastic material comprises a double laminated woven polyethylene with ultra violet stabilizer.

7. A plant-growing container according to claim 6 wherein the plastic material comprises a woven or fibre-reinforced material.

8. A plant-growing container according to claim 7 wherein the container comprises a plurality of holes scattered in a non-uniform manner to aid oxygen flow.

9. A plant-growing container according to claim 8 wherein the upper part of the container comprises a folded, double-thickness construction.

10. A method of cultivating trees comprising: using a container of claim 1, in hard-surfaced areas wherein the trees, grown in containers of translucent plastics sheet with a base and sides, are planted with retention of the upper part of the container sides as a root barrier, the lower part of the sides and the base being discarded.
